(19) United States
(12) Patent Application Publication
(10) Pub. No.: US 2012/0279019 A1
(43) Pub. Date: Nov. 8, 2012

(54) DEFORMABLE PAPER CLIP

(76) Inventor: Terry Cassaday, Mississauga (CA)

(21) Appl. No.: 13/101,493

(22) Filed: May 5, 2011

(51) Int. Cl. B42F 1/00; F16B 2/20

(52) U.S. Cl. 24/67.5; 24/457; 24/67 R

(57) ABSTRACT

This invention relates to a paper clip for releasably securing paper together having folded sheet metal defining a base and two spaced arms connected together by a first spring system and a cam member comprising sheet metal and having a deformable cam surface defining a second spring system operably connected to the two spaced arms for rotational movement between: an open position for insertion of the sheets between the base and deformable cam surface; and a closed position where rotation of the cam member rotates the deformable surface to releasably secure the sheets together between the deformable cam surface and base. The invention also relates to a paper clip having three spring systems and a method of releasably securing paper together.

### FIELD OF INVENTION

This invention relates to a clip for securing sheets together and in particular relates to a paper clip for releasably securing paper together having a base and a deformable cam surface operatively connected to the base for rotational movement between an open position for insertion of the paper and a closed position where rotation of the deformable surface rotates the deformable surface for releasably securing the paper between the deformable cam surface and base; and includes the method of clamping the paper there between. The clip and method accommodate different thicknesses of paper.

### BACKGROUND TO THE INVENTION

The prior art discloses many fastening devices for fastening, clamping, or gripping substantially flat articles such as sheet material or the like. Such fastening devices can include clipboards, staples, paper clips and the like for holding, fastening or clamping a plurality of sheets, fabric, paper or other material together. Clips can also be used to fasten one item to another or attach one item to another. In particular it is well known to employ staples as well as paper clips to hold sheets of paper together such as the standard metal oblong-shaped paper clip or the metallic clamping paper clip having two pressure bearing legs that must be separated to insert paper there between.

For example U.S. Pat. No. 7,500,301 discloses a method of clamping paper in a paper clip where the paper clip has spaced first and second opposed surfaces connected together at a rear edge and a cam member having a tab at one end thereof and a cam surface at another end thereof whereby the tab is moved between an open and closed position. The first and second opposed surfaces comprised of bent metal.

Another arrangement is disclosed in U.S. Pat. No. 6,637,716 which teaches a poster clasp for suspending a poster and includes a suspension assembly having at least one suspension device for operable, suspending cooperation with a surface; and a clasp assembly being formed integrally, unitarily with the suspension assembly, the clasp assembly having a support member and a hinged gripping member, the support member having a cam point formed integral with a back plate, and the hinged gripping member having a hingedly rotatable compression fin, the compression fin being rotatable between an open disposition and a closed disposition, the compression fin being formed integral with a hinge and being formed of a relatively soft material. A method of engaging a poster for the suspension thereof by means of a poster clasp is further included.

Yet another arrangement is shown in U.S. Pat. No. 6,018,850 which discloses a clip for paper sheets which is injection moulded in one piece from plastic. The clip is cross-sectionally U-shaped, the two legs interconnected by a web being flat and their flat sides face one another. In the gap formed in this way between the two legs is placed a clamping leg, which is connected in one piece to the inside of one leg and from there is inclined in the direction of the other leg and in the direction of the web. The paper sheets are slid into the gap, it being possible for the clamping leg to deform, whilst making difficult a drawing out of the sheets.

U.S. Pat. No. 6,450,471 shows a poster clasp for suspending a poster therefrom and includes a suspension assembly having at least one suspension device for operable, suspending cooperation with a surface. A clasp assembly is formed integrally, unitarily with the suspension assembly. The clasp assembly has a support member and a hinged gripping member, the support member having a cam point formed integral with a back plate, and the hinged gripping member having a hingedly rotatable lobe, the lobe being rotatable between an open disposition and a closed disposition, the lobe cooperating with the cam point to exert a compressive, frictional force on a poster disposed between the lobe and the cam point when the lobe is in the closed disposition to capture the poster for suspension thereof. A method of engaging a poster for the suspension thereof by means of a poster clasp is further included.

U.S. Pat. No. 2,971,236 relates to a fastening device for gripping a baby diaper, comprising: a U-shaped frame of resilient material having a pair of opposed arms, the free end of the one of the arms having a pair of laterally extending stud journals, said one arm having a pair of slots extending rearwardly from the open end of the frame to form a pair of laterally spaced shoulders on opposite sides of the arm; and a swingable member of resilient, plastic material having a finger lever at one end and a pair of elements forming a forked portion at the other end, each of said elements including a cam head having an aperture adapted to be snapped upon and made a snug fit with one of the stud journals and a narrow guide portion extending between the cam head and the finger lever in alignment with one of the slots, said cam heads being swingable together between an open position and a closed position in which a diaper inserted between the opposed arms is gripped in spaced portions between a surface of each of the cam heads and the other of said arms, each of said guide portions being swingable with its respective cam head so as to enter into an aligned slop and bear against an adjacent shoulder so that each of the cam heads will be retained upon its respective stud journal as the cam heads grip the diaper in moving to closed position.

U.S. Pat. No. 1,984,969 discloses a collar holder compromising a bar having bifurcated ends to receive a collar therein, cam levers carried by the inner fractions of said bifurcated ends, inwardly projecting portions at the extremities of the outer fractions co-operating with the cam levers to bite into a collar with the levers are in clamping position, said inwardly projecting portions constituting round enlargements, and said cam levers having curved recesses conforming in shape to the enlargements.

Another arrangement is taught in U.S. Pat. No. 1,809,400 which relates to a fastener for holding hides or the like in a stretched condition on a frame, comprising a part having a handle and being adapted to be removably secured to said frame, a second part adapted to be removably secured to said hide and spring tension means between said parts.

Other prior art devices such as the oblong-shaped paper clip can snag an unwanted piece of paper which is attached to other papers and thereby be incorrectly filed.

These and other prior art devices such as the spring wire clip formed from spring steel having a triangular head with a pair of forwardly and inwardly extending legs have been designed to releasably secure paper together.

There is a need to provide a paper clip which is easily to manufacture, simple to operate and capable of accommodating various thicknesses of paper.

It is an aspect of this invention to provide a clip for releasable securing sheets together comprising: a base; a deformable cam surface operably connected to the base for rotational movement between: an open position for insertion of the sheets between the base and deformable surface; and a closed position where rotation of the cam surface releasably secures the sheets together between the deformable cam surface and base.

It is another aspect of this invention to provide a paper clip for releasably securing paper together comprising: a folded sheet metal defining a base and two spaced arms; a cam member comprising sheet metal and having a deformable cam surface operably connected to the two spaced arms for rotational movement between: an open position for insertion of the sheets between the base and deformable cam surface; and a closed position where rotation of the cam member rotates the deformable surface to releasably secure the sheets together between the deformable cam surface and base.

In one embodiment the cam member comprises sheet metal defining a tab section at one end and a folded second end presenting a deformable cam surface with a variable cross sectional profile when the cam member is moved to the closed position and a terminal end disposed between the first and second end.

In another embodiment the terminal end moves relative the tab as the deformable cam surface changes its cross sectional profile to accommodate different thicknesses of paper.

It is another aspect of the invention to provide a method of clamping paper in a paper clip having a base presenting two upstanding spaced arms and a cam member having a tab at one end and a cam surface with a deformable cross sectional profile at another end comprising the steps of: moving the tab to a first open position where the cam surface is displaced away from the base; inserting the paper between the base and the cam member; moving the tab to a closed position where the cam surface is displaced toward the base so as to vary the cross sectional profile of the deformable cam surface as the deformable cam surface compresses against the paper and base to clamp the paper between the deformable cam surface and the base.

Yet another aspect of this invention relates to a paper clip for releasably securing paper together comprising: folded sheet metal defining a base and two spaced arms; a cam member comprising sheet metal and having a deformable cam surface operably connected to the two spaced arms for rotational movement between: an open position for insertion of the sheets between the base and deformable cam surface; and a closed position where rotation of the cam member rotates the deformable surface to releasably secure the sheets together between the deformable cam surface and base; the deformable cam surface defining a first spring system and the base and two spaced arms connected by a second spring system.

### BRIEF DESCRIPTION OF THE DRAWINGS

FIG. 1 is a top perspective view of the paper clip in a closed position.

FIG. 2 is a side elevational view of the base.

FIG. 3 is a side elevational view of the cam member.

FIG. 4 is a top plan view of the base.

FIG. 5 is a top plan view of the cam member.

FIG. 6 is a side elevational view of the paper clip.

FIG. 7 is a top perspective view of another embodiment of a paperclip in a closed position.

FIG. 8 is a side elevational view of the base of FIG. 7.

FIG. 9 is a side elevational view of the cam member of FIG. 7.

FIG. 10 is a top plan view of the base of FIG. 7.

FIG. 11 is a bottom plan view of the base of FIG. 7.

FIG. 12 is a top plan view of the cam member of FIG. 7.

FIG. 13 is a bottom plan view of the cam member of FIG. 7.

FIG. 14 is a side elevational view of the paperclip of FIG. 7.

FIG. 15 is a top plan view of the paperclip of FIG. 7.

### DETAILED DESCRIPTION OF THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

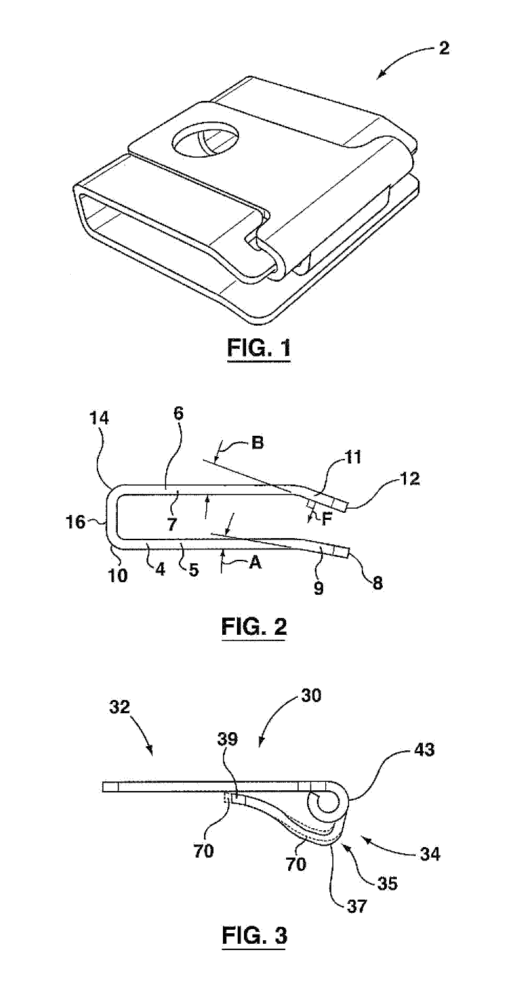

FIGS. 1, 2 and 3 illustrate one embodiment of the invention which comprises a clip 2 for securing sheet material 40 together. In particular the paper clip 2 has opposed first 4 and second 6 spaced surfaces. The first surface 4 has a forward edge 8 and a rear edge 10 while the second opposed surface 6 also has a forward edge 12 and a rear edge 14. The rear edges 10 and 14 of first and second opposed surfaces 4 and 6 respectively are connected together by a connecting member 16 so as to permit insertion of sheet material such as paper 40 through the forward edges 8 and 12 between the first and second surfaces 4 and 6 respectively. The connecting member 16 defining a jaw 16.

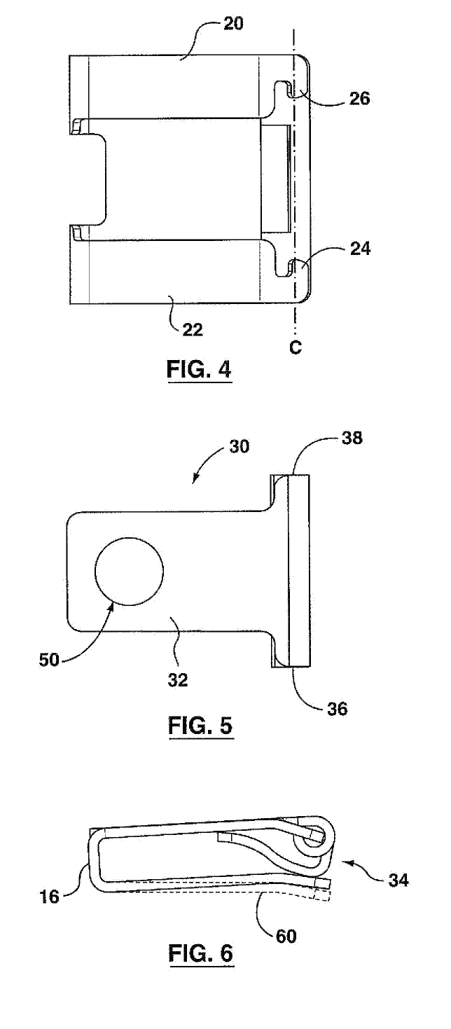

The first opposed surface 4 also defines a base which extends upwardly through the connecting member 16 and merge with the second surface 6. The second surface 6 includes spaced arms 20 and 22. In particular the spaced arms 20 and 22 are carried by the second surface 6 as best illustrated in FIG. 4. In this way the base 4 extends upwardly to present two spaced apart arms 20 and 22.

The first surface or base 4 has a substantially flat portion 5 as shown. The forward edge 8 of the base 4 has a first angled portion 9 relative the substantially flat portion 5 which is disposed at a first acute angle A which for example can be 10 degrees. The spaced arms 20 and 22 each have a substantially flat portion 7 as shown. The forward edge 12 of the arms 20 and 22 each have a second angled portion 11 relative the substantially flat portion 7 which are disposed at a second acute angle B which for example can be 20 degrees. The first and second angled portions are disposed at different acute angles relative the flat portions 5 and 7 respectively so as to inhibit the accidental insertion of paper into the clip. Moreover since the second angled surface 11 is at an angle greater than the first angled surface the force F created by the cam (to be described) will be in a direction generally normal, or at substantially 90 degrees from the angled surface 11, but in a direction which will tend to push paper into the clip 2. In other words the force F is not generally normal or at substantially at 90 degrees relative to the first surface 5 but rather at a direction which will have a component substantially parallel to the flat portion 5 tending to push paper into the clip. The angles A and B at 10 and 20 degrees have been used as an example but may be any angle so long as they are in accordance with the invention described herein.

The spaced arms 20 and 22 each present locating fingers 24 and 26 which are axially aligned along axis C. and extend for a short distance between the arms 20 and 22. The locating fingers are flat but cooperate with the cam member so as to present the axis of rotation C in a manner to be described.

The base can be comprised of any suitable material such as plastic or the like, but in one embodiment it has been found that sheet metal such as sheet steel is well adapted for the invention herein. In one embodiment the sheet steel can be stamped from a flat sheet of metal having the profile shown and then bent to present the profile shown in FIG. 2. The bent sheet metal having the first and second angled portions will provide the required “springiness” to allow the paper clip to releasably secure the paper. In particular the jaw 16 is a spring when paper is inserted into the paper clip in the closed position as shown in FIG. 6 as shown by the phantom lines 60. In other words the jaw flexes to accommodate different thicknesses of paper 40.

The second surface 6 includes a cam member 30. The cam member 30 is generally illustrated in FIGS. 3 and 5 and consists at one end thereof a tab member 32 which is operably movable as described herein and furthermore the cam member 30 also includes a deformable cam surface 34 which comprises of an enlarged portion at another end of the cam member 30 as best illustrated in FIG. 3. The cam portion 34 includes two opposed holes 36 and 38 which are axially aligned along axis C and adapted to receive the locating fingers 24 and 26 respectively.

In one embodiment the cam member 30 can be produced from a flat sheet of metal which is stamped to produce the profile show. In particular the deformable cam surface 34 can be bent in a machine well know to those persons skilled in the art. The deformable cam surface has the cross sectional profile shown having an elongated slightly curved portion 35 and a rounded contact portion 37 bent beyond itself to present a terminal end 39 which is presented just below the underside of the flat portion 41 as shown. In other words the stamped metal sheet is bent so as to present a looped second end wherein the deformable cam surface comprises a looped surface capable of being compressed when the deformable cam surface is rotated to the closed position to clamp the paper between the deformable cam surface and the base.

The cam member also presents along the forward edge 43 two spaced locating holes which are produced from the flat stamped sheet metal by being curled or rounded in a machine well known to persons skilled in the art so as to present the holes 36 and 38.

The cam member 30 can be comprised of a variety of materials such as plastic or the like and in one embodiment consists of sheet metal such as sheet steel. The locating fingers 20 and 22 are slightly rounded and tapered to permit the cam member to be operatively connected to the base 6; as the arms 20 and 22 flexibly spread apart to accommodate the insertion of the cam member 30 between the arms 20 and 22 and the registration of the locating fingers 20 and 22 within the holes 36 and 38 respectively; for rotational displacement or movement of the cam member 30 relative arms 20 and 22.

As can be seen from FIG. 1 the locating fingers 24 and 26 are suitably angled to permit the easy insertion of the cam member 30 so that the axis A of the locating fingers 24 and 26 co-axially align with the axis A of holes 36 and 38.

FIGS. 1 and 6 illustrates the paper clip 2 in a closed position showing the assembly of the cam member 30 relative the arms 20 and 22. In particular one can see the insertion of the locating fingers 24 and 26 within the holes 36 and 38 respectively. Moreover FIG. 1 illustrates that in the closed position the cam deformable cam surface 34 contacts the base 4 so as to exert the optimum force there between and grip the paper. In other words there is no gap. However the benefits of the invention may still be realized if there was a space or gap between the cam portion 34 and base 4 in the closed position particularly if one desired to clip a large stack of paper.

The tab member 30 is adapted for displaceable movement about axis C relative the base 4 as well as the first and second opposed surfaces 4 and 6 from an open position as shown by the phantom lines in FIG. 6 to a closed position as shown in FIGS. 1 and 6.

More particularly as the tab member 30 is rotated to the closed position the cam surface 34 will contact the paper and compress against the paper, whereby the side cross sectional profile compresses causing the terminal end 39 to move (to the left as shown in FIG. 6) relative the underside of the tab member 30. In other words the cross sectional profile of the deformable cam surface will change or vary depending on the thickness of the paper. The greater the thickness of paper the greater the spring compression of the cross sectional profile of the deformable cam surface. The deformable cam surface contacts the paper and the first angled portion 9 in the closed position.

In the closed position the spacing between the first and second angled portion will yield due to the “springiness” of the sheet steel. Also the cross sectional profile of the deformable cam surface will be squashed or compressed to increase the force F and permit the releasable securement of a thicker stack of paper. As shown by the phantom lines 70 in FIG. 3, once the paper clip is moved to the open position the end terminal 39 will move back to its original position and the cross sectional profile of the deformable cam surface 34 will also move back to its original position. In other words the deformable cam surface is a first spring system.

Moreover the “springiness” of the jaw 16 defines a second spring system and acts in combination with the first spring system of the deformable cam. In other words the paper clip 2 has two spring systems, the deformable cam surface 30 and the jaw 16.

Also the bent sheet metal having the first and second angled portions provide a “springiness” to allow the paper clip to releasably secure the paper so as to define a third spring system. The deformable cam surface is a first spring system as described, the jaw 16 a second spring system as described and the angled portions define a third spring system as the two angled portions are at different angles, and the angled portions “spring” move or deform relative to the flat portions 5 and 7 respectively. Therefore the invention herein also defines a paper clip having three spring systems that combine and co-act to accommodate different thickness of paper.

Furthermore as can be seen from a detailed side elevational view of FIG. 6 the base or first surface 4 includes an angled forward portion 9 for inhibiting the accidental insertion of paper 40 once the paper clip is in its closed position. The angled forward portion 9 blocks entry of paper into the cavity defined by first and second surfaces and connecting member 16, when the paper clip 2 is in the closed position. The second angled portion 11 diverts paper 40 away from the clip 2.

In one embodiment the invention describes a paper clip 2 for releasably securing paper 40 together comprising: folded sheet metal defining a base 4 and two spaced arms 20 and 22; a cam member 30 comprising sheet metal and having a deformable cam surface 34 operably connected to the two spaced arms 20 and 22 for rotational movement between: an open position for insertion of the sheets 40 between the base 4 and deformable cam surface 34; and a closed position where rotation of the cam member 30 rotates the deformable surface to releasably secure the sheets 40 together between the deformable cam surface 34 and base 4.

In another embodiment the invention describes a method of clamping paper 40 in a paper clip 2 having a base 4 presenting two upstanding spaced arms 20 and 22 and a cam member 30 having a tab 32 at one end and a cam surface 34 with a deformable cross sectional profile at another end comprising the steps of: moving the tab 32 to a first open position where the cam surface 34 is displaced away from the base 4; inserting the paper between the base and the cam member; moving the tab 32 to a closed position where the cam surface 34 is displaced toward the base 4 so as to vary the cross sectional profile of the deformable cam surface 34 as the deformable cam surface 34 compresses against the paper 40 and base 4 to clamp the paper 40 between the deformable cam surface 34 and the base 4.

The tab 32 includes a hole 50 therethrough to lighten the paper clip 2 as well as provide a surface which is easily manipulated by a user. Also there is a cut out 52 which extends from the rear edge 10 of the base and connecting member 16 which then merges with the space between the arms 20 and 22. The cut out 52 provides easy access to the tab 32 so as to move the paper clip 2 from a closed to open position.

In yet another embodiment the invention describes a paper clip having two spring systems and three spring systems.

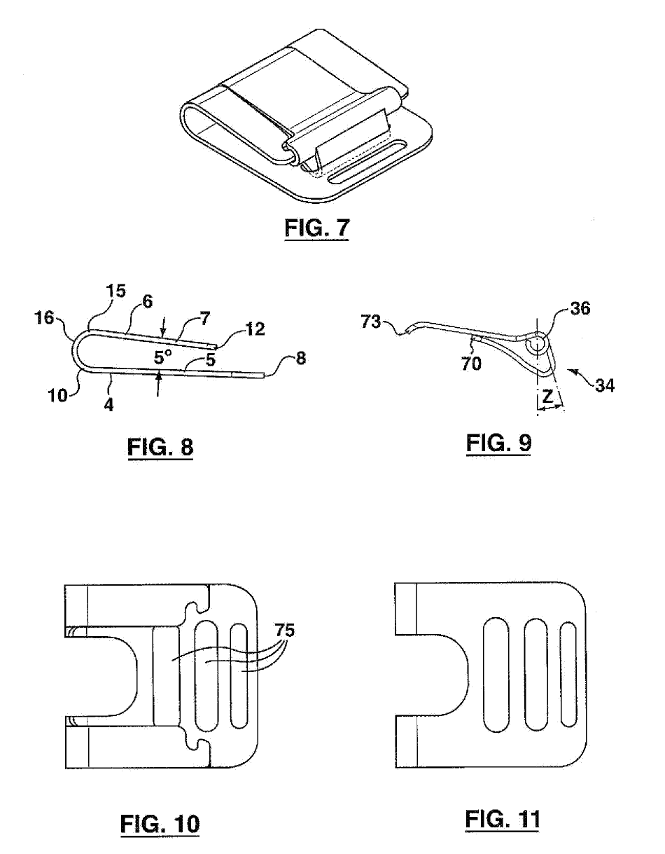

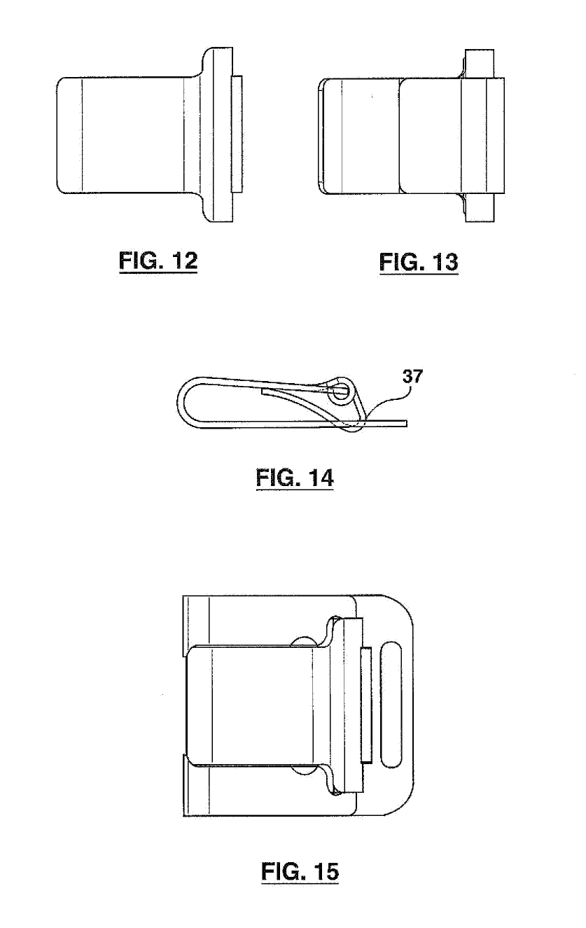

FIG. 7-15 inclusive illustrate a further embodiment of the invention which again comprises a clip 2 for securing sheet material 40 together. The paper clip 2 has opposed first 4 and second 6 space surfaces. The first surface 4 has a forward edge 8 and a rear edge 10 while the second opposed surface 6 also has a forward edge 12 and a rear edge 14. The rear edges 10 and 14 are the first and second opposed surfaces 4 and 6 respectively are connected together by a connecting member 16 so as to permit insertion of sheet material such as paper 40 through the forward edges 8 and 12 between the first and second surfaces 4 and 6 respectively. The connecting member 16 defining a jaw 16.

The first surface or base 4 has a substantially flat portion 5 as shown. The forward edge 8 of the base 4 in FIG. 8 is different from FIG. 2 as it does not include an angled portion. However, the spaced arms 20 and 22 have a substantially flat portion 7 as shown (again with no angled front portion). However the substantially flat portion 7 is disposed at an angle relative to the flat portion 5 as shown. In one embodiment the substantially flat portion 7 is disposed at a 5 degree angle relative to the flat portion 5, although other angles can be used. The disposition of the flat portions 5 and 7 at an angle provide the paper clip with a degree of springiness.

Furthermore, the base 4 includes a plurality of oblong holes 75 which co-act with the deformable cam surface 34 to assist in trapping paper as shown in FIG. 13. In the embodiment shown in FIG. 13 the deformable cam surface 34 protrudes through the oblong hole 75.

Moreover the rounded contact portion 37 as shown in the embodiment of FIG. 9 is disposed at an acute angle Z to the right of the vertical centre line. In particular the rounded contact portion 37 can in one example be disposed at 20 degrees from the vertical axis of hole 36. As the thickness of the paper to be clamped increase the contact surface 37 of FIGS. 9 and 13 will tend to be displaced or deformed to the right or in a counter clockwise direction thereby adding to the compressive or springing force imparted to the clamped paper. Furthermore the terminal end 70 of the deformable cam member 30 of the second embodiment shown in FIG. 9 will tend to move to the right relative to the substantially flat portion of the cam 30. This is slightly different from the embodiment shown in FIG. 3 whereby the rounded contact portion 37 of the embodiment shown in FIG. 3 is disposed at an acute angle to the left of the vertical centre line and will tend to move to the left or in a clockwise direction relative to the hole 36. Also, the terminal end 70 of FIG. 3 will tend to move to the left.

Moreover, the cam member 30 of FIG. 9 has a curved tabbed portion at the end which is disposed in line with the jaw member 16 as best seen in FIG. 13. The cam member 30 can be easily moved to the open position by lifting the end 73 in an upwardly direction when viewed in FIG. 13 and moved in a clockwise position whereby the contact surface 37 will be moved out of the hole 75 to permit insertion of paper between the cam member 30 and the base 4 as previously described.

Various embodiments of the invention have now been described in detail. Since changes to the various embodiments can be made without departing from the nature, spirit or scope of the invention, the invention is not to be limited to said details.

We claim:

1. A clip for releasable securing sheets together comprising:
(a) a base;
(b) a deformable cam surface operably connected to the base for rotational movement between:
(i) an open position for insertion of the sheets between the base and deformable surface; and
(ii) a closed position where rotation of the cam surface releasably secures the sheets together between the deformable cam surface and base.

2. A clip as claimed in claim 1 wherein the sheets comprise paper having a thickness.

3. A clip as claimed in claim 2 wherein the deformable cam surface has a cross sectional profile capable of deformation.

4. A clip as claimed in claim 2 wherein the deformable cam surface has a cross sectional profile that varies with the thickness of the paper.

5. A clip as claimed in claim 4 wherein the base and deformable cam surface comprises sheet metal.

6. A clip as claimed in claim 4 wherein the base comprises two upstanding spaced arms operatively connected to the deformable cam surface.

7. A clip as claimed in claim 6 wherein the base and the arms have a substantially flat portion and where the substantially flat portion of the arms are disposed substantially parallel to the flat portion of the base.

8. A clip as claimed in claim 7 wherein the base has a forward edge disposed at a first angle relative the flat portion of the base.

9. A clip as claimed in claim 8 wherein the arms have a forward edge disposed at a second angle relative to the flat portion of the arms.

10. A clip as claimed in claim 9 wherein the second angle is greater than the first angle.

11. A clip as claimed in claim 10 wherein the deformable cam surface comprises a looped surface capable of being compressed when the deformable cam surface is rotated to the closed position to clamp the paper between the deformable cam surface and the base.

12. A clip as claimed in claim 11 wherein the looped surface presents a terminal end, where the terminal end moves when the deformable cam surface is compressed against the paper in the closed position so as to change the cross sectional profile of the deformable cam surface.

13. A paper clip for releasably securing paper together comprising:
(a) folded sheet metal defining a base and two spaced arms;
(b) a cam member comprising sheet metal and having a deformable cam surface operably connected to the two spaced arms for rotational movement between:
(i) an open position for insertion of the sheets between the base and deformable cam surface; and
(ii) a closed position where rotation of the cam member rotates the deformable surface to releasably secure the sheets together between the deformable cam surface and base.

14. A paper clip as claimed in claim 13 wherein the cam member comprises sheet metal defining a tab section at one end and a folded second end presenting a deformable cam surface with a variable cross sectional profile when the cam member is moved to the closed position and a terminal end disposed between the first and second end; said deformable cam surface defining a first spring system.

15. A paper clip as claimed in claim 14 wherein the base and the arms have a substantially flat portion joined together by a jaw defining a second spring system, and where the substantially flat portion of the arms are disposed substantially parallel to the flat portion of the base.

16. A clip as claimed in claim 15 wherein the base has a forward edge disposed at a first angle relative the flat portion of the base.

17. A clip as claimed in claim 16 wherein the arms have a forward edge disposed at a second angle relative to the flat portion of the arms.

18. A clip as claimed in claim 17 wherein the second angle is greater than the first angle.

19. A method of clamping paper in a paper clip having a base presenting two upstanding spaced arms and a cam member having a tab at one end and a cam surface with a deformable cross sectional profile at another end comprising the steps of:
(a) moving the tab to a first open position where the cam surface is displaced away from the base;
(b) inserting the paper between the base and the cam member;
(c) moving the tab to a closed position where the cam surface is displaced toward the base so as to vary the cross sectional profile of the deformable cam surface as the deformable cam surface compresses against the paper and base to clamp the paper between the deformable cam surface and the base.

20. A method as claimed in claim 19 wherein the cam member comprises folded sheet metal presenting the tab at one end and the deformable cam surface at another end and a moveable terminal end between the tab and deformable cam surface; the terminal end moveable relative the tab and deformable cam surface when the paper is clamped in the closed position.

21. A paper clip for releasably securing paper together comprising:
(a) folded sheet metal defining a base and two spaced arms;
(b) a cam member comprising sheet metal and having a deformable cam surface operably connected to the two spaced arms for rotational movement between:
(i) an open position for insertion of the sheets between the base and deformable cam surface; and
(ii) a closed position where rotation of the cam member rotates the deformable surface to releasably secure the sheets together between the deformable cam surface and base.
(c) the deformable cam surface defining a first spring system and the base and two spaced arms connected by a second spring system.

22. A paper clip as claimed in claim 21 wherein the base and the arms have a substantially flat portion joined together by a jaw defining the second spring system, and where the substantially flat portion of the arms are disposed substantially parallel to the flat portion of the base and wherein the base has a forward edge disposed at a first angle relative the flat portion of the base and wherein the arms have a forward edge disposed at a second angle relative to the flat portion of the arms; the forward edge disposed at a first angle relative the flat portion of the base and the forward edges of the arms disposed at a second angle relative to the flat portion of the arms define a third spring system.
